(19) United States
(12) Patent Application Publication
(10) Pub. No.: US 2026/0148672 A1
(43) Pub. Date: May 28, 2026

(54) ENERGY EFFICIENT LUMINANCE MAPPING FOR DISPLAYS

(71) Applicant: SAMSUNG ELECTRONICS CO., LTD., Gyeonggi-Do (KR)

(72) Inventors: Dung Trung Vo, Costa Mesa, CA (US); Chenguang Liu, Tustin, CA (US); McClain Craig Nelson, Anaheim, CA (US)

(21) Appl. No.: 19/244,955

(22) Filed: Jun. 20, 2025

Related U.S. Application Data
(60) Provisional application No. 63/726,187, filed on Nov. 27, 2024.

(51) Int. Cl. G09G 3/20

(52) U.S. Cl. CPC G09G 3/2007; G09G 2320/0633; G09G 2320/0646; G09G 2330/023

(57) ABSTRACT

Energy efficient luminance mapping for display devices includes assigning pixels of an image into a plurality of ranges based on luminance. The plurality of ranges includes at least one of a shadow range, a midtone range, or a highlight range. A modified image is generated by adjusting luminance levels of pixels in one or more of the plurality of ranges. The adjusting improves perceptual brightness of the modified image relative to the image based on one or more visual illusions. The adjusting also reduces power consumption of displaying the modified image on a display device relative to displaying the image on the display device.

### CROSS-REFERENCE TO RELATED APPLICATIONS

This application claims the benefit of U.S. Application No. 63/726,187 filed on Nov. 27, 2024, which is fully incorporated herein by reference.

### TECHNICAL FIELD

The disclosure relates to energy efficient operation of display devices and, more particularly, to energy efficient image display using luminance mapping.

### BACKGROUND

Recent trends in display devices, e.g., televisions, have favored ever larger displays with increasing resolutions. As the size and resolution of display devices continues to increase, the amount of power required by such devices also increases. The power requirements of modern display devices have, in some cases, begun to surpass regulatory requirements in certain countries. Increased power consumption also translates into increased cost of ownership of display devices for consumers.

More power-efficient display technologies such as Liquid Crystal Display (LCD), Light Emitting Diode (LED), and Organic LED (OLED) have been developed. Display devices built using these technologies generally consume less power than display devices of same/similar size built using other technologies such as Cathode Ray Tube (CRT) or Plasma. Still, in view of the push for ever-increasing sizes and resolutions, new models of display devices that utilize power efficient display technologies continue to consume increasing amounts of power each year.

Attempts to reduce power consumption of display devices have relied on techniques such as decreasing backlighting, decreasing contrast in displayed images, and/or decreasing brightness of displayed images. While reduction in power consumption is desirable, use of these techniques brings the undesirable consequence of degraded visual quality in the images that are displayed. The lower contrast and/or brightness makes displayed images appear darker and less colorful overall to viewers.

### SUMMARY

In one or more embodiments, a method includes assigning pixels of an image into a plurality of ranges based on luminance. The plurality of ranges includes at least one of a shadow range, a midtone range, or a highlight range. The method includes generating a modified image by adjusting luminance levels of pixels in one or more of the plurality of ranges. The adjusting improves perceptual brightness of the modified image relative to the image based on one or more visual illusions. The adjusting also reduces power consumption of displaying the modified image on a display device relative to displaying the image on the display device.

In one or more embodiments, a system includes one or more hardware processors adapted to perform image processing operations. The operations include assigning pixels of an image into a plurality of ranges based on luminance. The plurality of ranges includes at least one of a shadow range, a midtone range, or a highlight range. The operations include generating a modified image by adjusting luminance levels of pixels in one or more of the plurality of ranges. The adjusting improves perceptual brightness of the modified image relative to the image based on one or more visual illusions. The adjusting also reduces power consumption of displaying the modified image on a display device relative to displaying the image on the display device.

In one or more embodiments, a computer program product includes one or more computer readable storage mediums, and program instructions collectively stored on the one or more computer readable storage mediums. The program instructions are executable by one or more hardware processors to perform operations. The operations include assigning pixels of an image into a plurality of ranges based on luminance. The plurality of ranges includes at least one of a shadow range, a midtone range, or a highlight range. The operations include generating a modified image by adjusting luminance levels of pixels in one or more of the plurality of ranges. The adjusting improves perceptual brightness of the modified image relative to the image based on one or more visual illusions. The adjusting also reduces power consumption of displaying the modified image on a display device relative to displaying the image on the display device.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings show one or more embodiments; however, the accompanying drawings should not be taken to limit the disclosed technology to only the embodiments shown. Various aspects and advantages will become apparent upon review of the following detailed description and upon reference to the drawings.

FIG. 1 illustrates a display device capable of performing image processing for reduced power consumption in accordance with one or more embodiments of the disclosed technology.

FIG. 2 illustrates another display device capable of performing image processing for reduced power consumption in accordance with one or more embodiments of the disclosed technology.

FIG. 3 illustrates an implementation of a virtual input generator in accordance with one or more embodiments of the disclosed technology.

FIGS. 4A-4D, taken collectively, illustrate image processing that reduces luminance levels of pixels in a shadow range of an image in accordance with one or more embodiments of the disclosed technology.

FIG. 5 illustrates another implementation of a virtual input generator in accordance with one or more embodiments of the disclosed technology.

FIGS. 6A-6D, taken collectively, illustrate image processing that reduces luminance levels of pixels in a midtone range of an image in accordance with one or more embodiments of the disclosed technology.

FIG. 7 illustrates another implementation of a virtual input generator in accordance with one or more embodiments of the disclosed technology.

FIGS. 8A-8D, taken collectively, illustrate image processing that reduces luminance levels of pixels in a highlight range of an image in accordance with one or more embodiments of the disclosed technology.

FIG. 9 illustrates another implementation of a virtual input generator in accordance with one or more embodiments of the disclosed technology.

FIGS. 10A-10C, taken collectively, illustrate image processing that modifies luminance levels of pixels in each of a shadow range, a midtone range, and a highlight range of an image in accordance with one or more embodiments of the disclosed technology.

FIGS. 11A and 11B illustrate an example of the simultaneous noise effect used in accordance with some embodiments of the disclosed technology.

FIG. 12 illustrates another implementation of a virtual input generator in accordance with one or more embodiments of the disclosed technology.

FIG. 13 illustrates another implementation of a virtual input generator in accordance with one or more embodiments of the disclosed technology.

FIG. 14 illustrates another example implementation of a display device capable of performing image processing for reduced power consumption in accordance with one or more embodiments of the disclosed technology.

FIG. 15 illustrates another implementation of a virtual input generator in accordance with one or more embodiments of the disclosed technology.

FIG. 16 illustrates an example implementation of the neural network of FIG. 15 in accordance with one or more embodiments of the disclosed technology.

FIG. 17 illustrates an example of a Graphical User Interface (GUI) for use generating training data for training the neural network in accordance with one or more embodiments of the disclosed technology.

FIG. 18 illustrates another example of the GUI of FIG. 17 illustrating state of the controls for the Bernstein curve coefficients subsequent to the user generating a modified image having a reduced power characteristic.

FIG. 19 is a graph illustrating convergence of the training error and the testing error during training of the neural network.

FIG. 20 illustrates a comparison of a curve of graded pixel pairs of a sample image to the fitted curve and the predicted curve from the neural network as trained.

FIG. 21 illustrates another implementation of the virtual input generator in accordance with one or more embodiments of the disclosed technology.

FIG. 22 illustrates a graded curve for a selected image as generated by a colorist compared to the predicted curve from the neural network using a combined lookup table (LUT) architecture in accordance with one or more embodiments of the disclosed technology.

FIG. 23 illustrates a method of image processing in accordance with one or more embodiments of the disclosed technology.

FIG. 24 illustrates another method of image processing in accordance with one or more embodiments of the disclosed technology.

FIG. 25 illustrates an example of a data processing system for use with the disclosed technology.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to energy efficient operation of display devices and, more particularly, to energy efficient image display using luminance mapping. In some embodiments, the disclosed technology generates a virtual input from a received input. The received input may be or include one or more images. Examples of images that may be received as input include a single image, a plurality of images such as sequential frames of an animation, a video, or other multimedia content. The virtual input may be used for different post processing purposes. For example, the virtual input may be used by a display device for power-saving. The virtual input specifies a modified version of one or more received images that, when displayed by a display device, consumes less power than is needed to display the images of the received input (e.g., prior to performing any power saving image processing). Further, the virtual input will have a quality, e.g., contrast and/or brightness, that is equivalent to, or better than, that of the images of the received input (prior to performing any power saving image processing).

The modified image(s) may be displayed by a display device to reduce power consumption of the display device while also preserving and, in at least some cases, improving, the quality of the images displayed. For example, the virtual input may have improved contrast and/or visual brightness compared to the original input. In one or more examples, the virtual input may be generated by adjusting luminance levels of pixels in one or more ranges for images of the virtual input. The ranges may include, but are not limited to, a highlight range, a midtone range, and a shadow range. In other examples, the ranges may be specified in terms of one or more percentages, e.g., of luminance. Other image processing techniques such as those that rely on or emphasize human visual illusions of stimulus contrast effect can be used to increase the perceptual brightness of images while still reducing the power required to display the virtual input.

In some embodiments, the virtual input may be generated using image processing techniques such as making the highlight ranges appear visually brighter by reducing the noise in the shadow and/or midtone ranges while keeping the highlight range unchanged. This technique may also reduce the amount of power required to display the virtual input in comparison to the original input. In other embodiments, the brightness of the highlight range may be reduced in combination or together with reductions in noise in the shadow and/or midtone ranges. This technique also may reduce the amount of power required to display the virtual input in comparison to the original input.

In other examples, the virtual input may be generated using image processing techniques that make the highlight range appear visually brighter by sharpening the highlight range while keeping the shadow and/or midtone ranges unchanged. In still other examples, the brightness of the highlight range may be reduced or pushed down in combination with the sharpening process described.

In some embodiments, the image processing techniques described within this disclosure may use an artificial intelligence-based approach that is capable of generating or approximating a Bernstein curve. The Bernstein curve may be used to modify or adjust the luminance levels of pixels of image(s) to generate a virtual input that requires less power to display than the original input, where the virtual input also has improved contrast and/or visual brightness compared to the original input. The input may be processed through a lookup (LUT) table that adjusts luminance of pixels in one or more or all of the shadow, midtone, and/or highlight ranges based on the Bernstein curve to generate the virtual input and realize reduced power consumption in the display device. In some embodiments, the disclosed technology can combine the LUT described in connection with achieving reduced power consumption with another LUT that implements a tone mapping process to produce a joint LUT that may be used to process images.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

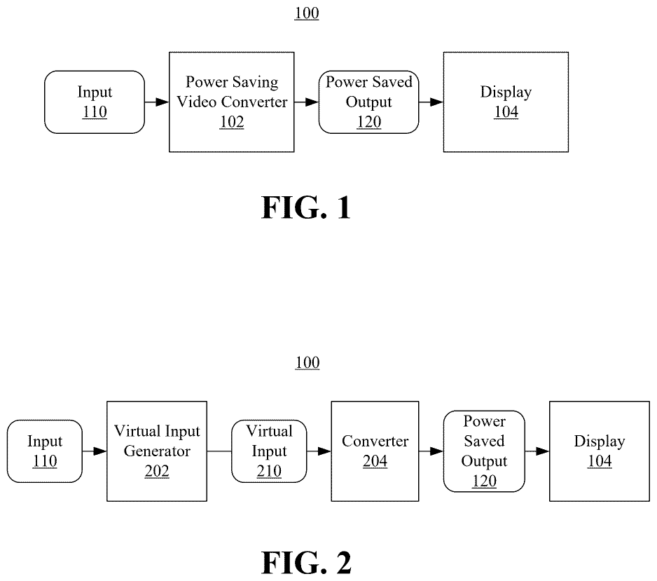

FIG. 1 illustrates a display device 100 capable of performing image processing for reduced power consumption in accordance with one or more embodiments of the disclosed technology. Examples of display devices such as display device 100 can include, but are not limited to, a television, a computer monitor, a computing device such as a laptop or tablet, a mobile device such as a mobile phone, an information appliance, gaming system with or coupled to a display, or a wearable device such as virtual reality glasses, smartwatch, or the like.

In the example of FIG. 1, the display device 100 includes a power saving video converter 102 coupled to a display 104. Power saving video converter 102 is capable of receiving an input 110 and generating a power saved output 120. Input 110 may include one more images, e.g., frames, of a video or other portion of multimedia content. Power saved output 120 includes modified versions of the images.

In one or more embodiments, images of input 110 may be standard dynamic range (SDR) images with power saved output 120 also being SDR images. In one or more other embodiments, images of input 110 may be SDR images while power saved output 120 may be high dynamic range (HDR) images. In still other embodiments, images of input 110 may be HDR images and power saved output 120 also may be HDR images.

In one or more embodiments, power saving video converter 102 is implemented as image processing circuitry, e.g., hardware. Such hardware may include one or more image processors such as specialized Application-Specific Integrated Circuits (ASICs), Graphics Processing Units (GPUs), Digital Signal Processors (DSPs), Intellectual Property (IP) cores, other circuits, etc., that are designed to perform particular image processing operations, functions, and/or algorithms.

In one or more embodiments, power saving video converter 102 is capable of implementing conventional image processing techniques that convert an input into a suitable form or output for displaying on a display device. For example, conventional image processing that may be performed by power saving video converter 102 may include, but is not limited to, contrast enhancement, brightness enhancement, sharpening, dynamic range conversion, denoising, and the like. These operations, however, are uncorrelated with reducing power expended by a display device to display the resulting output.

Power saving video converter 102 is capable of performing additional image processing that is capable of generating power saved output 120. Images of power saved output 120 have a reduced power characteristic in that a display device may display or render power saved output 120 while consuming or expending less power compared to displaying or rendering an output generated by a conventional converter and/or images of input 110. Examples of the image processing techniques that may be performed by power saving video converter 102 may include, but are not limited to, reducing the luminance levels of pixels in at least one of the shadow range, the midtone range, or the highlight range of the image; reducing the luminance levels of pixels in the shadow and highlight ranges while increasing the luminance levels of pixels in the midtone range; making the highlight range appear visually brighter by removing noise from the shadow range and/or the midtone range of the image while keeping the highlight range unchanged; making the highlight range appear visually brighter by sharpening the highlight range while keeping the shadow and/or midtone ranges unchanged; reducing the brightness of the highlight range in combination with reducing noise in the shadow and/or midtone ranges; and/or reducing or pushing down the luminance level of pixels in highlight range in combination with the sharpening process.

The example of FIG. 1 commingles image processing functions that reduce power consumption with other conventional video conversion processes. Commingling these functions may require modification of existing, e.g., conventional, image processing algorithms and/or hardware architectures.

In any case, the resulting images, e.g., power saved output 120, may be displayed or rendered on display 104. As discussed, the display of power saved output 120 on display 104 requires less power expenditure by display 104 and display device 100 than had the power saving image processing not been performed. For purposes of illustration and not limitation, display 104 may be implemented as a Liquid Crystal Display (LCD), a Light Emitting Diode (LED) display, an Organic LED (OLED) display, a plasma display, and/or a cathode ray tube (CRT) display.

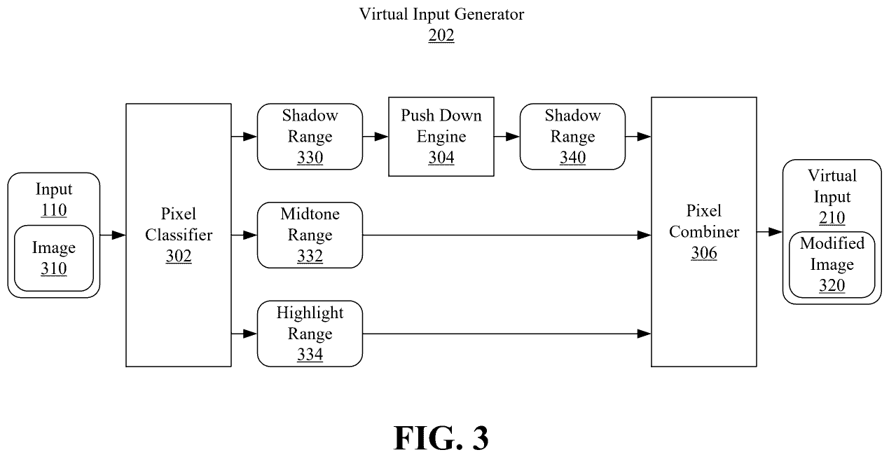

FIG. 2 illustrates another implementation of display device 100 capable of performing image processing for reduced power consumption in accordance with one or more embodiments of the disclosed technology. In the example of FIG. 2, display device 100 includes a virtual input generator 202 and a converter 204. Virtual input generator 202 is capable of receiving input 110 and generating a virtual input 210. Virtual input 210 is a modified version of input 110 that has reduced power characteristics. Unlike the example of FIG. 1, virtual input 210 may still require further image processing performed by a conventional converter such as converter 204 as may be found in display devices in order to display or render images of input 110 or, in this case virtual input 210, on display 104. Accordingly, converter 204 generates power saved output 120 from virtual input 210 that may be displayed on display 104.

In the example of FIG. 2, the power saving image processing operations are separated from the conventional image processing operations performed by display device 100. This allows the power saving image processing operations to be added to existing display devices without substantial redesign of the image processing architecture or pipeline. In other words, while the power saving image processing in the example of FIG. 1 may affect other conventional image processing performed to display images (e.g., frames of video), the power saving image processing in the example of FIG. 2, as implemented by virtual input generator 202, does not. Converter 204 may operate on virtual input 210 in the same way that converter 204 would operate on input 110. This means that any conventional hardware and/or software implementations of converter 204 may continue to be used with a hardware and/or software implementation of virtual input generator 202 preceding converter 204 to realize a reduction in power consumption of the display device while maintaining or improving perceived image quality.

The virtual input creation process illustrated in FIG. 2 as implemented by virtual input generator 202 may be utilized in any of a variety of different applications, contexts, and/or use cases. For example, virtual input generator 202 may be used to generate a virtual input for other applications including, but not limited to contrast enhancement, brightness enhancement, sharpening, dynamic range conversion, denoising, or the like. For example, display devices may use virtual input 210 for power saving while maintaining the same or improved visual quality in terms of brightness and/or contrast. In general, the same image processing operations described in connection with FIG. 1 with respect to achieving reduced power consumption may be implemented by virtual input generator 202.

In the example of FIG. 2, each of virtual input generator 202 and converter 204 may be implemented as separate image processing circuitry or hardware or implemented in a single image processing circuit/hardware. Such hardware may include one or more image processors such as specialized ASICs, GPUs, DSPs, IP cores, other circuits, etc., that are designed to perform the particular image processing operations, functions, and/or algorithms described herein.

FIG. 2 illustrates an example of a framework that is capable of generating a virtual input and using a virtual input that is hardware efficient and compatible with available post-processing image-processing operations whether implemented in hardware and/or software. In one or more examples, images of input 110 and images of virtual input 210 both may be SDR images. In another example, images of input 110 and images of virtual input 210 both may be HDR images. In some cases, SDR images may be converted to HDR images prior to being displayed.

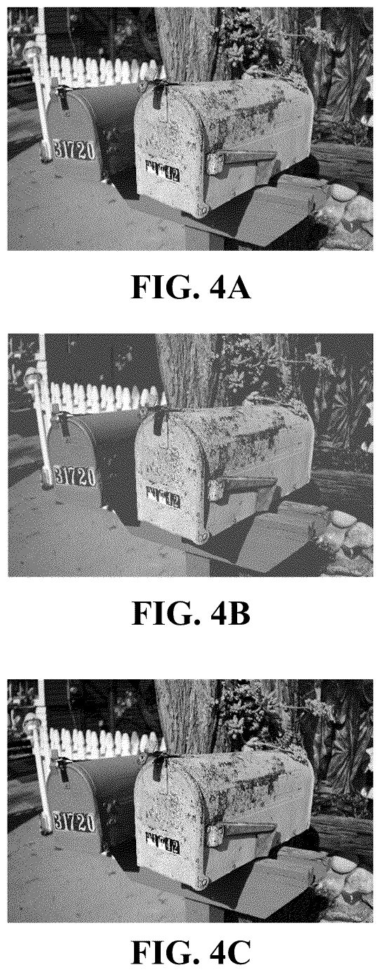

FIG. 3 illustrates an implementation of virtual input generator 202 of FIG. 2 in accordance with one or more embodiments of the disclosed technology. The example implementation of virtual input generator 202 is capable of performing a sectional modification of input 110 to generate virtual input 210. More particularly, the example implementation of virtual input generator 202 of FIG. 3 is capable of operating on, e.g., pushing down, pixels of the shadow range of images of input 110.

For purposes of illustration, operation of virtual input generator 202 is described within this disclosure in the context of processing a single image 310 of input 110. It should be appreciated, however, that virtual input generator 202 may operate on a plurality of images or frames in sequence of input 110.

In the example, virtual input generator 202 includes a pixel classifier 302 and a pixel combiner 306. Pixel classifier 302 is capable of detecting luminance of pixels in image 310 and assigning, e.g., classifying or dividing, the pixels of image 310 into a shadow range 330, a midtone range 332, and a highlight range 334 based on the luminance level of each pixel. In one or more embodiments, pixel classifier 302 is capable of dividing pixels of images, e.g., on a per-image basis, based on a maximum luminance (max_lum) of the image. For example, pixel classifier 302 is capable of dividing pixels having a luminance level in the range of 0<max_lum/3 into shadow range 330, pixels having a luminance level in the range max_lum/3<2*max_lum/3 into midtone range 332, and pixels having a luminance level in the range of 2*max_lum/3≤max_lum into highlight range 334.

In the example, push down engine 304 operates only on pixels of shadow range 330. Push down engine 304 is capable of pushing down, or reducing, the luminance levels of pixels, e.g., each pixel, of shadow range 330 of image 310 and generating shadow range 340 (e.g., a version of shadow range 330 having pixels with reduced luminance). Reducing the luminance of pixels in shadow range 330 reduces the power consumption of display 104 in displaying the image while simultaneously increasing contrast of the image. Pixel combiner 306 is capable of receiving shadow range 340, midtone range 332, and highlight range 334 for the image and combining the respective ranges to construct a modified image 320 that may be output as virtual input 210.

In the examples described herein, each push down engine and/or push up engine may be configured to push down/up luminance of pixels of the relevant ranges by a predetermined amount. The predetermined amount may be an absolute and predetermined number or a predetermined percentage that may be calculated based on the brightest pixels in the relevant range. In any case, the push up/down may be applied to each pixel in the selected or given range (e.g., the shadow range in this example).

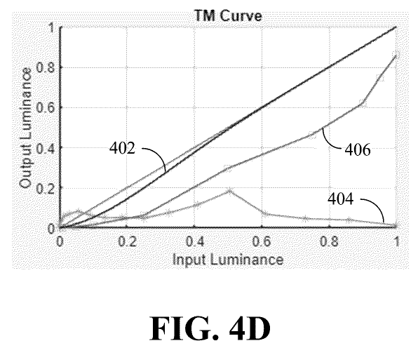

FIGS. 4A-4D, taken collectively, illustrate example processing performed by virtual input generator 202 of FIG. 3. FIG. 4A illustrates an example of image 310. FIG. 4B illustrates shadow range 330 as detected by pixel classifier 302 prior to operation of push down engine 304. FIG. 4C illustrates modified image 320 after operation of push down engine 304 and pixel combiner 306. FIG. 4C illustrates that modified image 320, which includes shadow range 340, has a higher contrast than image 310 of FIG. 4A and requires less power to display than image 310. FIG. 4D illustrates a luminance modification curve 402 that is implemented or applied to push down pixels in shadow range 330 by push down engine 304. Luminance modification curve 402 is illustrated relative to a histogram 404 shown in green and a percentile of pixel luminance 406 for image 310.

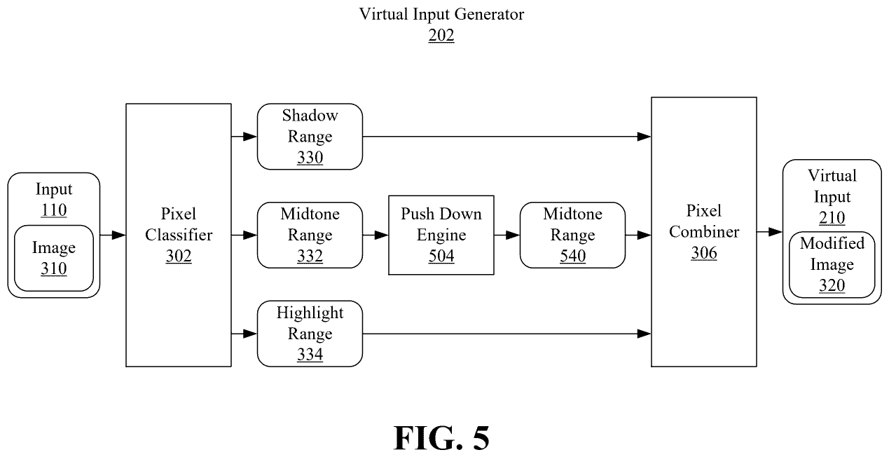

FIG. 5 illustrates another implementation of virtual input generator 202 of FIG. 2 in accordance with one or more embodiments of the disclosed technology. The example implementation of virtual input generator 202 is capable of performing a sectional modification of input 110 to generate virtual input 210. More particularly, the example implementation of virtual input generator 202 is capable of operating on, e.g., pushing down, pixels of midtone range 332 of image 310.

In the example, pixel classifier 302 and pixel combiner 306 are capable of operating substantially as described in connection with FIG. 3. In the example, push down engine 504 operates only on pixels of midtone range 332. Push down engine 504 is capable of pushing down, or reducing, the luminance levels of pixels, e.g., each pixel, of midtone range 332 for image 310 and generating midtone range 540 (e.g., a version of midtone range 332 having pixels with reduced luminance). Reducing the luminance of pixels in midtone range 332 reduces the power consumption of display 104 in displaying the image while simultaneously increasing contrast of the image. Pixel combiner 306 is capable of receiving shadow range 330, midtone range 540, and highlight range 334 for image 310 and combining the respective ranges to construct modified image 320 that may be output as virtual input 210.

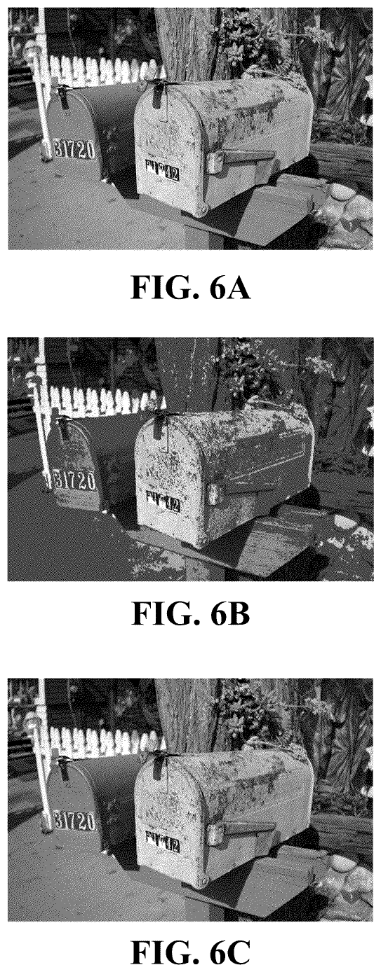

FIGS. 6A-6D, taken collectively, illustrate example processing performed by virtual input generator 202 of FIG. 5. FIG. 6A illustrates an example of image 310. FIG. 6B illustrates midtone range 332 as detected by pixel classifier 302 prior to operation of push down engine 504. FIG. 6C illustrates modified image 320 after operation of push down engine 504 and pixel combiner 306. FIG. 6C illustrates that modified image 320, which includes midtone range 540, has a higher contrast than image 310 of FIG. 6A and requires less power to display than image 310. FIG. 6D illustrates a luminance modification curve 602 that is implemented or applied to pixels in midtone range 332 by push down engine 504. The luminance modification curve 602 is illustrated relative to a histogram 604 and a percentile of pixel luminance 606 for image 310.

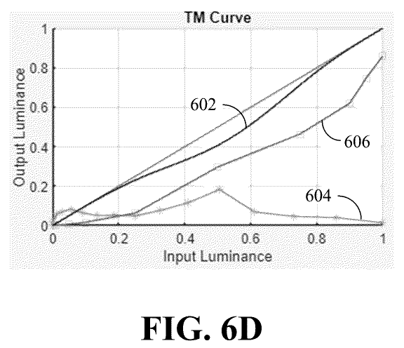

FIG. 7 illustrates another implementation of virtual input generator 202 of FIG. 2 in accordance with one or more embodiments of the disclosed technology. The example implementation of virtual input generator 202 is capable of performing a sectional modification of input 110 to generate virtual input 210. More particularly, the example implementation of virtual input generator 202 is capable of operating on, e.g., pushing down, pixels of highlight range 334 of image 310.

In the example, pixel classifier 302 and pixel combiner 306 are capable of operating substantially as described in connection with FIG. 3. In the example, push down engine 704 operates only on pixels of highlight range 334. Push down engine 704 is capable of pushing down, or reducing, the luminance levels of pixels, e.g., each pixel, of highlight range 334 for image 310 and generating highlight range 740 (e.g., a version of highlight range 334 having pixels with reduced luminance). Reducing the luminance of pixels in highlight range 334 reduces the power consumption of display 104 in displaying the image while simultaneously increasing contrast of the image. Pixel combiner 306 is capable of receiving shadow range 330, midtone range 332, and highlight range 740 for image 310 and combining the respective ranges to construct modified image 320 that may be output as virtual input 210.

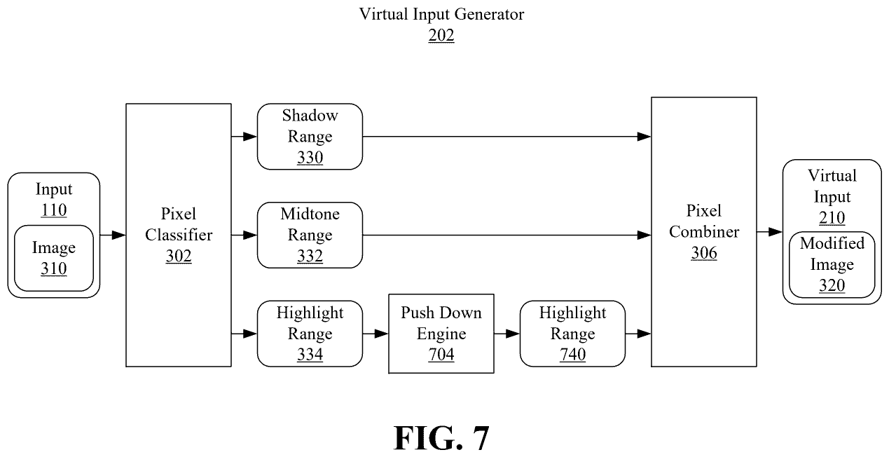

FIGS. 8A-8D, taken collectively, illustrate example processing performed by virtual input generator 202 of FIG. 7. FIG. 8A illustrates an example of image 310. FIG. 8B illustrates highlight range 334 as detected by pixel classifier 302 prior to operation of push down engine 704. FIG. 8C illustrates modified image 320 after operation of push down engine 704 and pixel combiner 306. FIG. 8C illustrates that modified image 320, which includes highlight range 740, has a higher contrast than image 310 of FIG. 8A and requires less power to display than image 310. FIG. 8D illustrates a luminance modification curve 802 that is implemented or applied to pixels in highlight range 334 by push down engine 704. The luminance modification curve 802 is illustrated relative to a histogram 804 and a percentile of pixel luminance 806 of image 310.

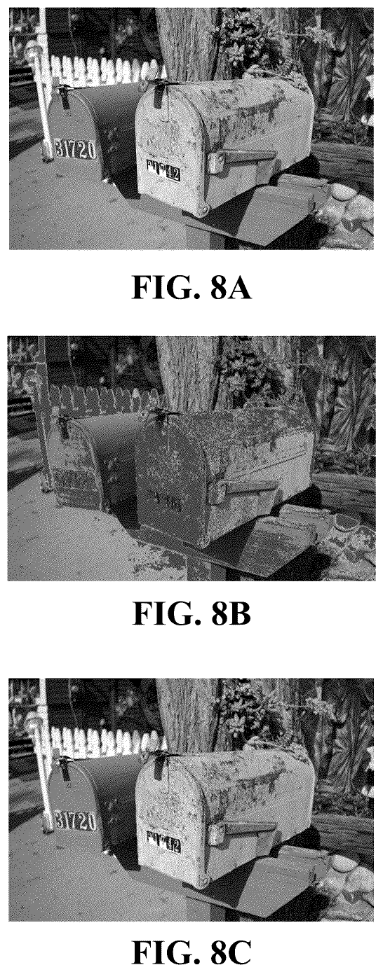

FIG. 9 illustrates another implementation of virtual input generator 202 of FIG. 2 in accordance with one or more embodiments of the disclosed technology. The example implementation of virtual input generator 202 is capable of performing a sectional modification of input 110 to generate virtual input 210. More particularly, the example implementation of virtual input generator 202 of FIG. 2 is capable of pushing down pixels of shadow range 330 and of highlight range 334 while pushing up pixels of midtone range 332 of image 310.

In the example, pixel classifier 302 and pixel combiner 306 are capable of operating substantially as described in connection with FIG. 3. In the example, push down engine 304 operates only on pixels of shadow range 330. Push down engine 304 is capable of pushing down, or reducing, the luminance levels of pixels, e.g., each pixel, of shadow range 330 for image 310 and generating shadow range 340. Push up engine 904 operates only on pixels of midtone range 332. Push up engine 904 is capable of pushing up, or increasing, the luminance levels of pixels, e.g., each pixel, of midtone range 332 for image 310 and generating midtone range 940. Push down engine 704 operates only on pixels of highlight range 334. Push down engine 704 is capable of pushing down, or reducing, the luminance levels of pixels, e.g., each pixel, of highlight range 334 for image 310 and generating highlight range 740.

Reducing the luminance of pixels in highlight range 334 and shadow range 330 reduces the power consumption of display 104 in displaying the image while simultaneously increasing contrast of the image. Pixel combiner 306 is capable of receiving shadow range 340, midtone range 940, and highlight range 740 for image 310 and combining the respective ranges to construct modified image 320 that may be output as virtual input 210. Reducing the luminance of pixels in shadow range 330 and in highlight range 334 and increasing the luminance of pixels in midtone range 332 reduces the power consumption of display 104 in displaying the image while simultaneously increasing contrast of the image.

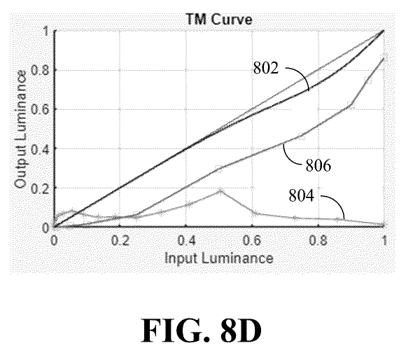

FIGS. 10A-10C, taken collectively, illustrate example processing performed by virtual input generator 202 of FIG. 9. FIG. 10A illustrates an example of image 310. Illustrations of shadow range 330, midtone range 332, and highlight range 334 for image 310 have already been illustrated. FIG. 10B illustrates modified image 320 after operation of push down engine 304, push up engine 904, push down engine 704, and pixel combiner 306. FIG. 10B illustrates that modified image 320, which includes shadow range 340, midtone range 940, and highlight range 740, has a higher contrast than image 310 of FIG. 10A and requires less power to display than image 310. In the example, image 320 of FIG. 10B has a darker shadow range and a darker highlight range. FIG. 10C illustrates a luminance modification curve 1002 that is implemented or applied to pixels shadow range 330, midtone range 332, and highlight range 334 by push down engine 304, push up engine 904, and push down engine 704, respectively. The luminance modification curve 1002 is illustrated relative to a histogram 1004 and a percentile of pixel luminance 1006 for image 310.

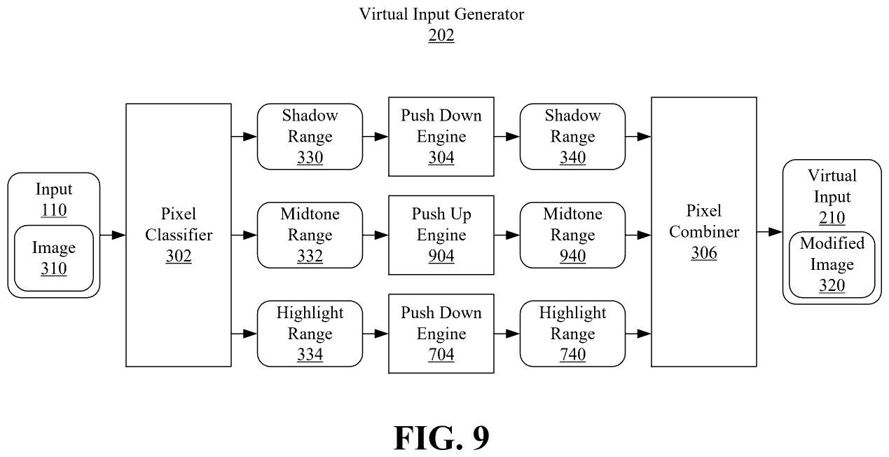

In one or more embodiments, virtual input generator 202 is capable of removing noise from one or more selected ranges of input 110 to generate virtual input 210. FIGS. 11A and 11B illustrate examples of the simultaneous noise effect. In the example of FIG. 11A, a transitional noisy dark background is illustrated in which transitional noise has been added to a fixed dark background. The noise variance is increased from left to right so that the noise becomes stronger moving from left to right. In the example of FIG. 11A, while the noise has zero mean such that pixels on the left and the right columns have the same mean, pixels in the right columns have a brighter feeling/appearance than pixels in the left columns.

FIG. 11B illustrates the same transitional noisy background from FIG. 11A with a grid of squares added to the foreground. Each row of the foreground squares has the same luminance. Even though the squares have the same luminance, the squares on the left appear to users as brighter than the squares on the right. This perceived difference occurs in consequence of the background having darker pixels on the left compared to the right.

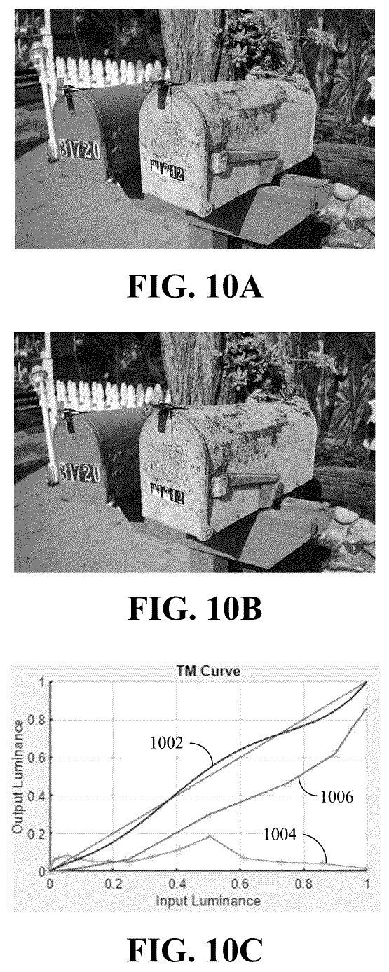

FIG. 12 illustrates another implementation of virtual input generator 202 of FIG. 2 in accordance with one or more embodiments of the disclosed technology. The example implementation of virtual input generator 202 is capable of removing noise from selected ranges of image 310 such as shadow range 330 and midtone range 332. The noise removal illustrated in FIG. 12 is based on luminance to generate the power saving result of virtual input 210. As illustrated, noise remover 1204 is capable of removing noise from shadow range 330 resulting in shadow range 1240. Noise remover 1206 is capable of removing noise from midtone range 332 resulting in midtone range 1242. In the example, noise remover 1204 and noise remover 1206 are capable of removing noise from shadow range 330 and midtone range 332, respectively. These operations make shadow range 1240 and midtone range 1242 appear darker than shadow range 330 and midtone range 332, respectively.

Pixel combiner 306 is capable of combining shadow range 1240, midtone range 1242, and highlight range 334 to construct modified image 320 that may be output as virtual input 210. Modified image 320, as output from pixel combiner 306, may be displayed using less power compared to display of image 310. Further, modified image 320 will appear to users as having improved contrast compared to image 310.

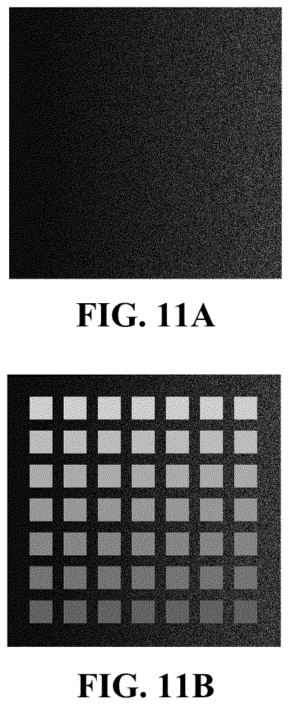

FIG. 13 illustrates virtual input generator 202 of FIG. 2 in accordance with one or more embodiments of the disclosed technology. The example implementation of virtual input generator 202 is capable of sharpening, i.e., edge sharpening, selected range(s) of image 310 such as highlight range 334. The sharpening is performed based on luminance to generate the power saving result of virtual input 210.

In the example of FIG. 13, sharpener 1306 is capable of adding high frequency components to image 310. In the example, sharpener 1306 sharpens edges of highlight range 334 resulting in highlight range 1334. Highlight areas in the image are sharpened to make these highlight edges have more contrast and higher brightness. The sharpening helps to increase the contrast of the whole image and to make the image appear visually brighter. The high-pass filter effect performed by sharpener 1306 has zero mean. As such, both image 310 and modified image 320, including highlight range 1334 therein, have the same mean value. Accordingly, modified image 320, in the example of FIG. 13, has higher contrast than image 310 and may be displayed using less power than image 310.

In one or more embodiments, the processing illustrated in FIG. 13 may be performed in combination with different types of sectional processing illustrated in FIG. 3 (shadow range push down), FIG. 5 (midtone range push down), FIG. 7 (highlight range push down), and FIG. 9 (shadow and highlight ranges push down with midtone range push up). For example, the processing illustrated in FIG. 13 may be performed prior to, e.g., precede, the processing illustrated in FIG. 3, 5, 7, or 9 to further reduce power consumption of a display device in displaying modified image 320. That is, use of the processing illustrated in FIG. 13 in combination with any one of the techniques illustrated in FIG. 3, 5, 7, or 9 will result in an image that consumes less power to display than the resulting image from any one of FIG. 3, 5, 7, 9, or 13 individually.

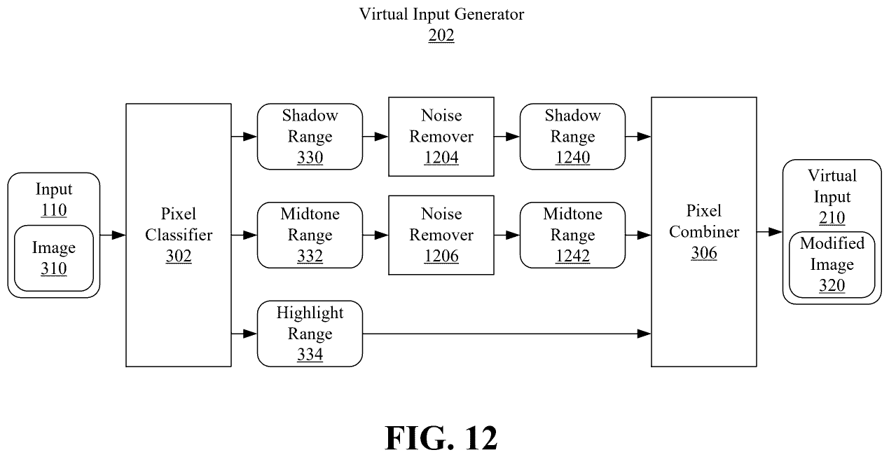

FIG. 14 illustrates another example implementation of display device 100 capable of performing image processing for reduced power consumption in accordance with one or more embodiments of the disclosed technology. In the example of FIG. 14, virtual input generator 202 is capable of receiving input 110 and generating virtual input 210. As discussed, virtual input 210 is a modified version of input 110 that has reduced power characteristics. As noted, input 110 may be an SDR input with virtual input 210 being an SDR output. Alternatively, input 110 may be an HDR input with virtual input 210 being an HDR output.

In the example of FIG. 14, for purpose of illustration, virtual input 210 is provided to a tone mapper 1404. Tone mapper 1404 may be configured to perform a variety of different image processing operations. In some examples, tone mapper 1404 may perform tone mapping to generate suitable output images/frames adapted for displaying on the particular display 104 included in display device 100. In some embodiments, tone mapper 1404 is capable of performing inverse tone mapping, e.g., an SDR to HDR conversion process also referred to as “up-mapping,” to convert SDR content to HDR content adapted for displaying on display 104. In that case, tone mapper 1404 is capable of enhancing the visual appearance of virtual input 210 by expanding the dynamic range and color gamut of virtual input 210 to correspond to, or match, HDR standards resulting in power saved output 1420, e.g., HDR output in this case. That is, displaying power saved output 1420 requires less power than displaying a tone mapped version of input 110 without performing the processing described in connection with virtual input generator 202.

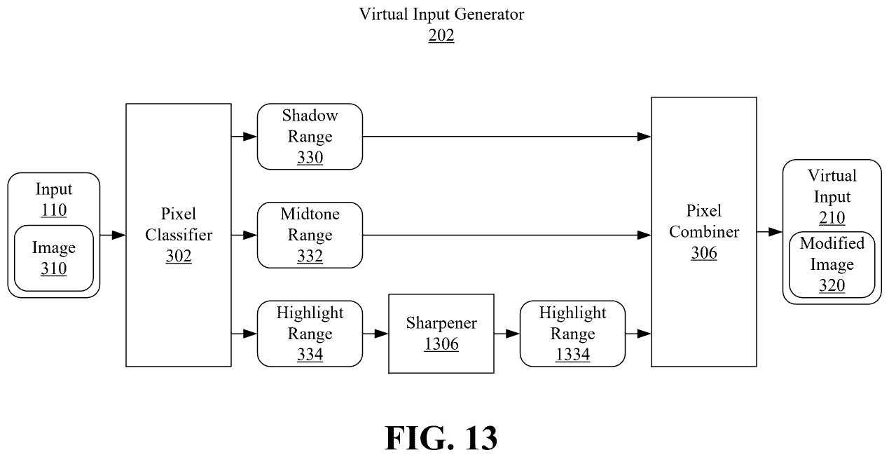

FIG. 15 illustrates another implementation of virtual input generator 202 in accordance with one or more embodiments of the disclosed technology. The example of FIG. 15 illustrates an example architecture for virtual input generator 202 that incorporates machine learning/artificial intelligence and uses a Bernstein curve to perform tone mapping to generate virtual input 210.

In the example of FIG. 15, virtual input generator 202 includes a histogram generator 1502, a percentile calculator 1504, a neural network 1506, a filter 1508, and a virtual tone mapper 1510. While each of the components will be described in greater detail hereinbelow, virtual tone mapper 1510 is capable of performing an SDR-to-SDR tone mapping to achieve power savings that utilizes a Bernstein curve. It should be appreciated that while aspects of FIG. 15 are described with reference to SDR images, the embodiments may also be applied to HDR images.

A Bernstein curve typically refers to a type of parametric curve defined using Bernstein polynomials as used in computer graphics. The Bernstein curve is illustrated below in Expression 1.

$$\tilde{y} = {Σ}_{i = 1}^{N = 10} {p}_{i}^{P S} ( \frac{10}{i} ) {x ( 1 - x )}^{10 - i} \qquad ( 1 )$$

In the example of Expression 1, x∈[0, 1] is the normalized SDR input pixel value, \tilde{y}∈[0, 1] is the predicted normalized SDR pixel virtual input value, and

$${p}_{i}^{PS}$$

are the 10^{th} order explicit Bernstein curve coefficients. The last Bernstein curve coefficient is set to 1 so that the peak luminance of the output frame, e.g., modified image 320, is the same as the peak luminance of the input frame, e.g., image 310. Expression 2 illustrates the last of the 10th order Bernstein curve coefficients.

$${p}_{10}^{PS} = 1 \qquad ( 2 )$$

In the example of FIG. 15, histogram generator 1502 is capable of generating a histogram of image 310. The histogram generated by histogram generator 1502 specifies the brightness level, or tone, of each pixel in image 310. Percentile calculator 1504 is capable of calculating percentiles based on brightness of the pixel as determined from the histogram generated by histogram generator 1502. For purposes of illustration and not limitation, 9 different percentiles may be used. An example of the different percentiles, denoted as lⱼ wherein j=1 to 9, that may be used by percentile calculator 1504 may include the percentiles: 1%, 5%, 10%, 25%, 50%, 75%, 90%, 95%, and 99.98%, where x∈[0, 1] is the normalized SDR input pixel value. As an illustrative and nonlimiting example, the 1% percentile includes the darkest 1% of the pixels of image 310, the 5% percentile includes the darkest 5% of the pixels of image 310 (e.g., inclusive of the darkest 1% of pixels), with each higher percentage range including the ranges beneath, and so forth. As such, percentile calculator 1504 outputs the 9 different percentiles for image 310, with each percentile including the pixels of image 310 assigned thereto. Appreciably, the percentiles described may map onto the various ranges previously discussed. That is, one or more or each of the percentiles may map onto, or correlate with, one or more of the highlight range, the midtone range, and/or the shadow range.

The percentiles are provided to neural network 1506 as input. Neural network 1506 is trained to generate the 10^{th} order Bernstein curve coefficients based on the received percentiles. Filter 1508 may be included to operate on the Bernstein curve coefficients as output from neural network 1506. In one or more examples, filter 1508 is implemented as an Infinite Impulse Response (IIR) filter. An IIR filter refers to a type of digital filter used in signal processing that utilizes feedback. This means that the output of the IIR filter depends not only on current and past input values, but also on past output values. Filter 1508 is operative to implement temporal smoothing in the changes in pixel luminance applied by virtual tone mapper 1510, which avoids visual artifacts such as flickering and/or flashing that may occur between images/frames/scenes that have different luminosity or have a difference in luminosity over a particular threshold amount.

In one or more embodiments, virtual tone mapper 1510 may be implemented as, or include, a LUT. Tone mapper 1510 is capable of receiving the output from filter 1508, e.g., the filtered Bernstein curve coefficients P1-P10, and generating a LUT from the Bernstein curve coefficients. The LUT specifies a discrete representation, or approximation, of the Bernstein curve specified by the smoothed coefficients. The LUT may be implemented as a predetermined number of entries for representing the Bernstein curve. For purposes of illustration, an example implementation of the LUT of tone mapper 1510 may have a depth of 11 bits and 2\hat{ }11=2048 entries. In other examples, the LUT may be reduced in size, to reduce computational complexity, to 256 uniformly distributed entries. Each pixel of image 310 may be processed using the LUT of virtual tone mapper 1510. That is, the luminance of each pixel of image 310 may be input to virtual tone mapper 1510 to look up a luminance from the LUT for that pixel. The luminance of each pixel of image 310 may be adjusted, based on the LUT, to generate modified image 320.

In one or more other embodiments, virtual tone mapper 1510 is capable of generating output luminance values for pixels given an input luminance value dynamically based on the filtered Bernstein curve coefficients, e.g., on the fly. For example, the translated luminance values for pixels to generate modified image 320 may be calculated for each pixel based on the Bernstein curve coefficients by processing circuitry in virtual tone mapper 1510 such that the LUT is not generated or fully regenerated. Given an input luminance, an output luminance may be calculated given the Bernstein coefficients. In some embodiments, as values are calculated, such values may be stored as entries in the LUT for reuse or subsequent recall to continue processing an image (e.g., building the LUT as the image is processed) at least until further images are processed and updates to the values are generated for subsequent images.

In some embodiments, whether using a LUT or dynamically generating the luminance values, e.g., on the fly, different ranges (e.g., shadow, midtone, highlight) may be adjusted by tone mapper 1510 as discussed in connection with FIGS. 3, 5, 7, and/or 9, e.g., based on the particular Bernstein curve represented by the filtered Bernstein curve coefficients and/or LUT. In general, the shadow range of image 310 is controlled and/or modified based on the portion of the Bernstein curve, as specified by the filtered Bernstein curve coefficients and/or LUT of virtual tone mapper 1510, defined by Bernstein curve coefficients P1, P2, and P3. The midtone range of image 310 is controlled and/or modified by the portion of the Bernstein curve, as specified by the filtered Bernstein curve coefficients and/or LUT of virtual tone mapper 1510, defined Bernstein curve coefficients P4, P5, and P6. The highlight range of image 310 is controlled and/or modified based on the portion of the Bernstein curve, as specified by the filtered Bernstein curve coefficients and/or LUT of virtual tone mapper 1510, defined by Bernstein curve coefficients P7, P8, and P9. As noted, P10 always has a value of 1. For any pixels having a luminance value not directly specified by the LUT, linear interpolation or another interpolative technique may be used to determine the output luminance of the pixel.

In the example of FIG. 15, it should be appreciated that the Bernstein coefficients are generated anew by neural network 1506 for each image 310 (e.g., for each frame) of input 110. In this regard, the particular Bernstein curve that is determined for each image 310 will change as will the filtered Bernstein coefficients and the values specified by the LUT of virtual tone mapper 1510 on a per image basis. For example, the LUT may be updated on a per image basis to specify a discrete representation of the Bernstein curve from the filtered Bernstein coefficients based on the most recent image and output from filter 1508. In effect, the LUT of virtual tone mapper 1510 is dynamically updated for each image/frame based on the smoothed Bernstein coefficients received.

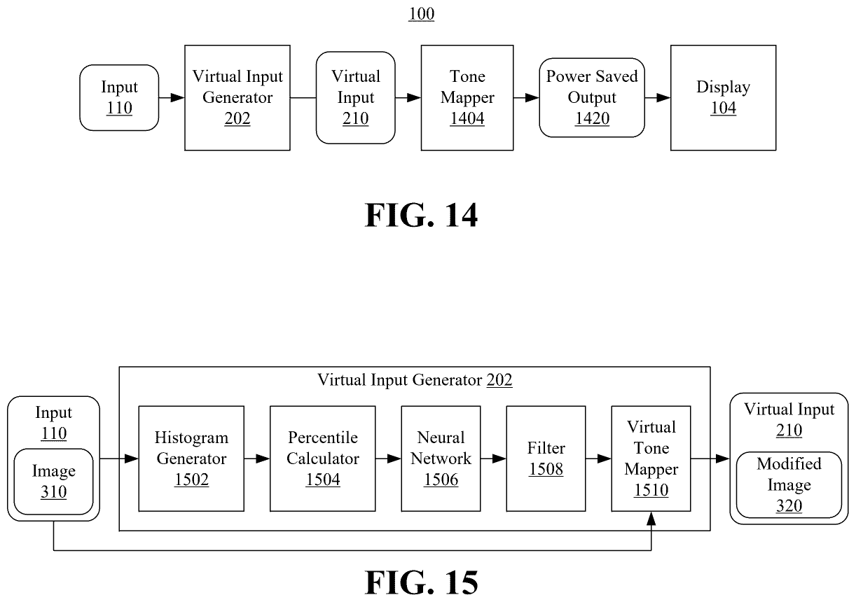

FIG. 16 illustrates an example implementation of neural network 1506 in accordance with one or more embodiments of the disclosed technology. As noted, neural network 1506 is capable of receiving inputs lⱼ and generating the Bernstein curve coefficients

$${p}_{i}^{PS} .$$

The percentiles lⱼ are estimated/calculated based on the histogram of image 310 generated by histogram generator 1502. In the example, neural network 1506 includes an input layer having 9 input neurons followed by a first hidden layer H2 having 14 neurons, followed by a second hidden layer H2 having 12 neurons, and an output layer having 10 output neurons, wherein each output neuron outputs a Bernstein coefficient. Each of the layers is fully connected. In one or more embodiments, neural network 1506 may be implemented as a multilayer perceptron network, though the disclosed technology is not intended to be limited by the particular type of neural network used.

In one or more embodiments, neural network 1506 may be trained using a training database that includes pairs of original input and virtual input where each pair includes an original SDR image and a processed SDR image, where the processed SDR image is processed or modified for power saving as described herein. For example, the processed images may be obtained from any of the processes illustrated in FIG. 3, 5, 7, or 9. In this example, for training purposes, the processed SDR images may be generated by video editors (e.g., human beings) that manually generate processed images using computer-based image processing tools. In some embodiments, the original SDR inputs may be sample images extracted from a portion of video for verifying power consumption of display devices.

In one or more other embodiments, neural network 1506 may be trained using a training database that includes pairs of original HDR input and virtual HDR input where each pair includes an original HDR image and a processed HDR image, where the processed HDR image is processed or modified for power saving as described herein. The processed HDR images may be generated by video editors (e.g., human beings) that manually generate processed images using computer-based image processing tools as described above. In this manner, the neural network may be trained to operate directly on HDR images. Accordingly, it should be appreciated that the discussion below is applicable for training the neural network to generate Bernstein coefficients for operating either SDR images or HDR images to generate a LUT for virtual tone mapper 1510.

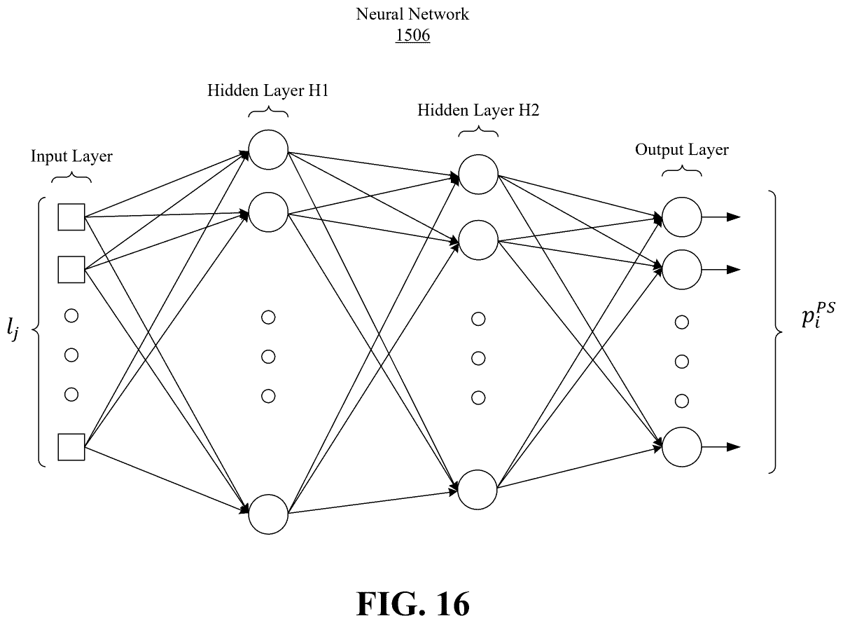

FIG. 17 illustrates an example of a Graphical User Interface (GUI) that may be used by a user such as a colorist to tune an original input to create a virtual input. For purposes of illustration, the GUI may be used with an image processing application such as MATLAB or other image processing application. In working with the GUI of FIG. 17, a user may tune an original input to generate a virtual input that, when displayed by a display device, consumes or requires less power than displaying the original input.

The GUI of FIG. 17 includes controls 1702 that allow a user to specify a particular value for each of the Bernstein curve coefficients P1 through P10. As noted, P10 may remain set to 1. The GUI of FIG. 17 allows a user to load a custom image, e.g., the original input, via control 1704 and view the histogram and percentiles of the loaded custom image in window 1706. Via the GUI of FIG. 17, the user may select a particular Bernstein coefficient via control 1708. The pixels affected by the Bernstein curve coefficient selected using control 1708 may be visually distinguished in the original input as displayed in window 1710 using a luminance range map. For purposes of illustration, the pixels affected by Bernstein curve coefficient P1 are visually distinguished in window 1710. The user may move the controls (e.g., sliders) for one or more or all of the Bernstein curve coefficients and view changes in the virtual input in window 1712 that may be committed to the virtual input.

Using control 1714, the user may toggle between the original input and the virtual input based on the current settings, or positions, of the Bernstein curve coefficient controls in window 1712. The user may save the virtual input using control 1716. The virtual input may be displayed on the display device, e.g., as a full screen image using the “full screen” control, to ensure that power consumption of the display device in displaying the virtual input is lower than the power consumption of the display device in displaying the original input. The user may create pairs as described to create the training data for neural network 1506.

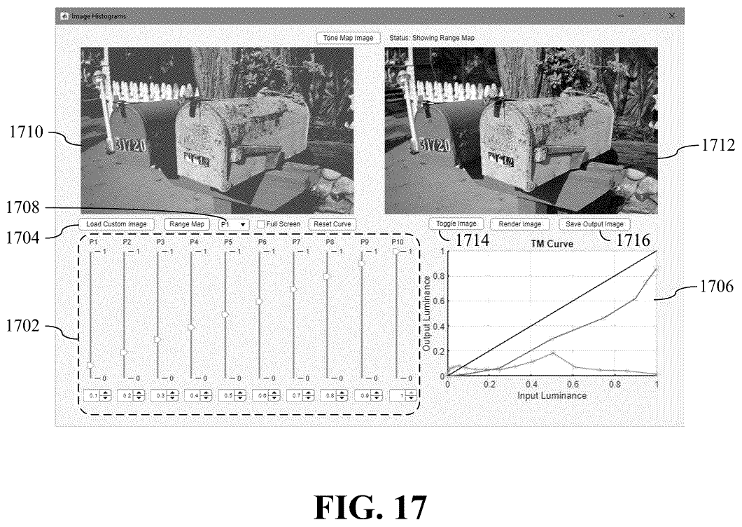

FIG. 18 illustrates an example state of the controls for the Bernstein curve coefficients subsequent to the user generating the virtual input having a reduced power characteristic for an original input. In the example, the virtual input, shown in window 1712, has a reduced power characteristic relative to the original input shown in window 1710. Further, the virtual input, having pixels of both the shadow range and midtone range pushed down compared to the original input, has increased overall contrast compared to the original input.

The training process trains neural network 1506 to fit a tone mapping curve that converts the training images (original inputs) to the output training images (virtual outputs) for each respective training pair. For each original input of a training pair, the percentile data are extracted (e.g., the nine percentiles 1, 5, 10, 25, 50, 75, 90, 95, 99.98) and used as input to neural network 1506 (e.g., each percentile being provided to a corresponding input node). Neural network 1506 is trained to output the 10^{th} order Bernstein coefficients

$${p}_{i}^{PS}$$

that match or approximate the Bernstein curve coefficients that, when applied to the original input of a training pair, result in the virtual input (e.g., processed image) of the pair.

For purposes of illustration and not limitation, the training may be performed using an algorithm such as the ADAM (Adaptive Moment Estimation) that adjusts the learning rate for each parameter individually based on the history of gradients. The training may be performed or controlled using Python. A learning rate of 2*10⁻⁴, a weight decay of 10⁻⁵, a patch size of 128 with shuffling, and epochs of 100,000 may be used in combination with a Mean Squared Error (MSE) loss function.

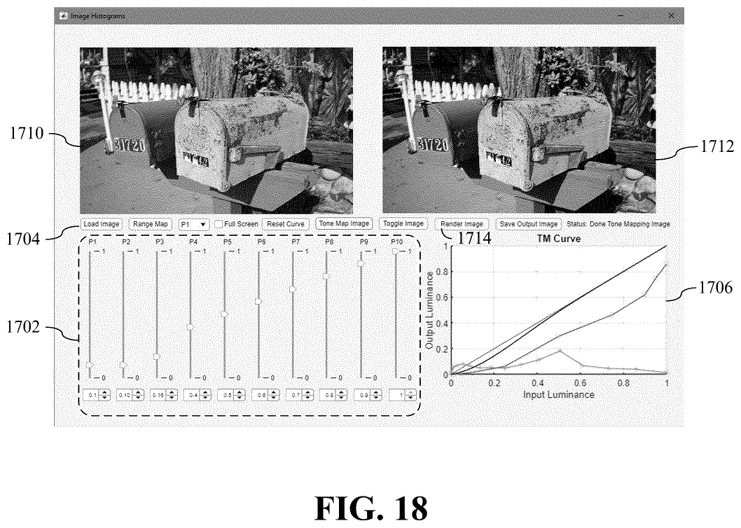

FIG. 19 illustrates the training error and the testing error during training. The dropping error from left to right verifies the convergence of the training process for neural network 1506. As discussed, once trained, neural network 1506 operates to perform inference by calculating the curve parameters in the form of the Bernstein curve coefficients. The Bernstein curve coefficients are provided to virtual tone mapper 1510, which generates virtual input 210.

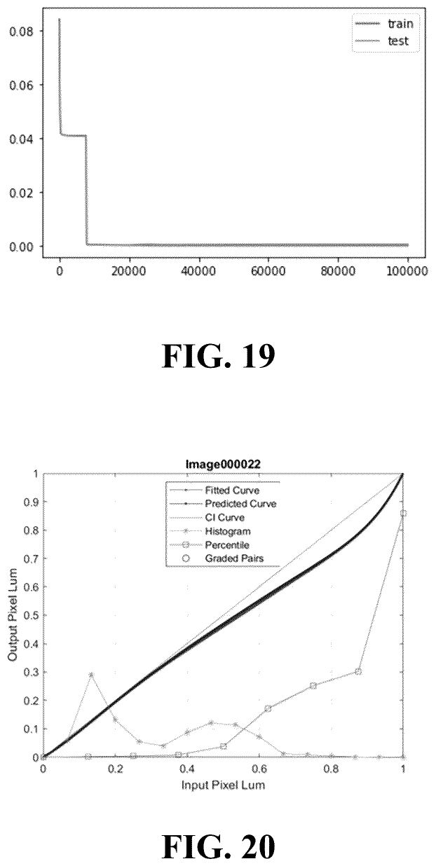

FIG. 20 illustrates a comparison of a curve of graded pixel pairs of a sample image to the fitted curve and the predicted curve from neural network 1506. FIG. 20 demonstrates that the predicted curve using neural network 1506, as trained, closely tracks the fitted curve and graded pixel pairs. FIG. 20 demonstrates that neural network 1506 is capable of learning and applying the grading style/technique of a particular colorist.

Referring again to the example of FIGS. 14 and 15, each of tone mapper 1510 and tone mapper 1404 may be implemented using a LUT. Tone mapper 1510 is adapted to achieve power saving while tone mapper 1404, in the example of FIG. 14, is adapted to convert SDR images to HDR images. In one or more embodiments, the two LUTs may be combined into a single LUT that allows for simpler and more efficient tone mapping.

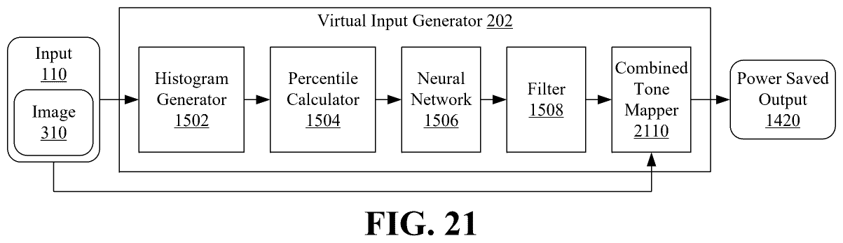

FIG. 21 illustrates another implementation of virtual input generator 202 in accordance with one or more embodiments of the disclosed technology. The example of FIG. 21 may be implemented substantially similar to that of FIG. 15. In the example of FIG. 21, however, virtual tone mapper 1510 is replaced with a combined tone mapper 2110 that implements both tone mapper 1404 and virtual tone mapper 1510 as a single LUT.

For purposes of illustration, consider an example implementation of virtual tone mapper 1510 having a depth of 11 bits and 2\hat{ }11=2048 entries. As noted, in some embodiments, the LUT may be reduced in size, to reduce computational complexity. As an illustrative and nonlimiting example, the LUT may be reduced to 256 uniformly distributed LUT entries denoted xₖ that may be calculated. Any other entries that may be needed can be calculated by interpolating the existing 256 available entries. The Bernstein curve coefficients generated by neural network 1506 may be fed into tone mapper 1510 to obtain the output luminance values of pixels to generate the virtual inputs 210 denoted as

$${\tilde{y}}_{k}^{P S}$$

in Expression 3 below.

$${\tilde{y}}_{k}^{P S} = {Σ}_{i = 1}^{N = 10} {p}_{i}^{P S} ( \frac{10}{i} ) {{x}_{k} ( 1 - {x}_{k} )}^{10 - i} \qquad ( 3 )$$

The virtual inputs

$${\tilde{y}}_{k}^{P S}$$

are processed through tone mapper 1404, which implements Expression 4. Expression 4 illustrates an example of inverse tone mapping curve

$${p}_{k}^{iTM}$$

this may be applied by way of a LUT to convert an SDR image to an HDR image.

$${\tilde{y}}_{k} = {Σ}_{k = 1}^{N = 10} {p}_{k}^{iTM} ( \frac{10}{i} ) {{\tilde{y}}_{k}^{P S} ( 1 - {\tilde{y}}_{k}^{P S} )}^{10 - i} \qquad ( 4 )$$

Given Expression 3 and Expression 4, a combined LUT ratio for each entry of the LUT of virtual tone mapper 1510 and the LUT of tone mapper 1404 may be calculated using the ratio illustrated in Expression 5 below. The results may be used to create a single LUT that may be included in combined tone mapper 2110 that implements the functionality of both virtual tone mapper 1510 and tone mapper 1404.

$${r}_{k} = \frac{{\tilde{y}}_{k}}{{x}_{k}} \qquad ( 5 )$$

In some embodiments, registers are declared/implemented that may be used to tune the curve parameters

$${p}_{i}^{PS}$$

thereby allowing the

$${p}_{i}^{PS}$$

values to be changed.

For purposes of illustration, combined tone mapper 2110 may be implemented by feeding 256 inputs into virtual tone mapper 1510 to obtain the virtual inputs. These 256 virtual inputs may then be fed into the tone mapper 1404 to obtain power saved output (e.g., 256 such outputs). Ratios of the 256 virtual inputs to the 256 power saved outputs may be calculated and stored as the entries in the LUT of combined tone mapper 2110. Other entries of the LUT of combined tone mapper 2110 may be interpolated based on existing entries.

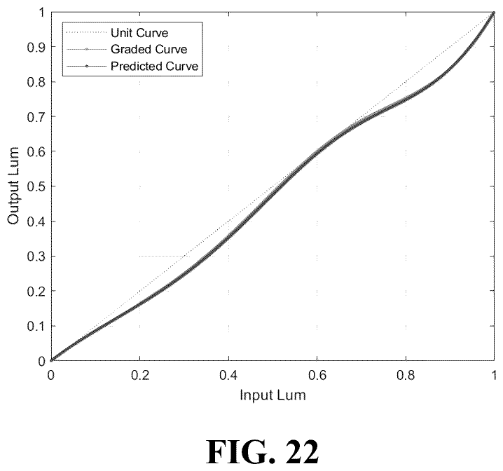

FIG. 22 illustrates a comparison of a graded curve for a selected image as generated by a colorist to the predicted curve from neural network 1506 using the combined LUT architecture illustrated in FIG. 21 in which virtual tone mapper 1510 and tone mapper 1404 are combined into combined tone mapper 2110 as discussed in connection with Expressions 3, 4, and 5. The example of FIG. 22 demonstrates that neural network 1506 is capable of learning and applying the grading style/technique of a particular colorist using the combined LUT technique.

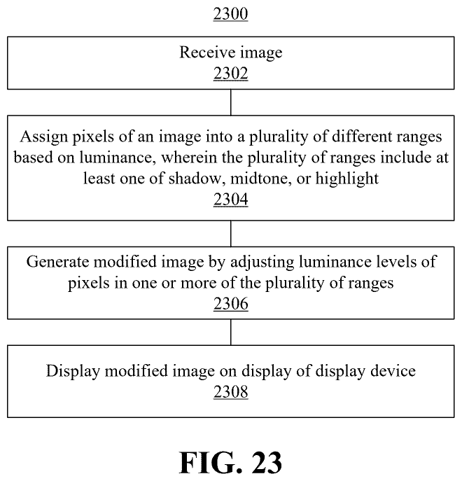

FIG. 23 illustrates a method 2300 of image processing in accordance with one or more embodiments of the disclosed technology. Method 2300 may be performed by a display device 100 as described in connection with FIG. 2 of this disclosure. The example of FIG. 23 is described with reference to processing an image. It should be appreciated that the processing described may be performed over a plurality of images, e.g., sequential frames, of multimedia content. Further, the operations described in connection with FIG. 23 may be performed on SDR images or on HDR images. Further, the processing described in connection with FIG. 23 may be performed in real-time to support real-time video and/or multimedia playback.

In block 2302, input 110, e.g., image 310, is received. In block 2304, virtual input generator 202 is capable of assigning, e.g., classifying or dividing, pixels of image 310 into a plurality of ranges based on luminance. The plurality of ranges can include at least one of a shadow range, a midtone range, or a highlight range. As discussed, pixel classifier 302 is capable of separating pixels of the image into the different ranges based on luminance.

In block 2306, virtual input generator 202 is capable of generating virtual input 210 including modified image 320 by adjusting luminance levels of pixels in one or more of the plurality of ranges. Pixel combiner 306 may generate modified image 320 from any of the various ranges of image 310 by combining the ranges, including any that have been modified. Adjusting luminance, as discussed, improves perceptual brightness (e.g., perceived contrast) of modified image 320 relative to image 310 based on one or more visual illusions. The visual illusions upon which improved perceptual brightness occurs include a simultaneous contrast effect (e.g., where an object displayed against a dark background will appear brighter to human beings compared to displaying the same object against a lighter background) or a Bartleson-Breneman effect (where image contract increases with luminance of surround lighting for emissive images/displays). Further, adjusting the luminance level of pixels reduces power consumption of displaying modified image 320 on a display device relative to displaying image 310 on the display device.

For example, in block 2306, adjusting the luminance level of pixels in one or more of the plurality of ranges may include reducing the luminance of pixels in at least one of the shadow range, the midtone range, or the highlight range of the image as described in connection with FIGS. 3, 5, and/or 7, respectively. Alternatively, adjusting the luminance level of pixels in one or more of the plurality of ranges as performed in block 2306 can include performing each of the following operations on image 310 (e.g., in parallel/concurrently): reducing the luminance of pixels in the shadow range, reducing the luminance of pixels in the highlight range, and increasing the luminance of pixels in the midtone range as described in connection with FIG. 9.

In one or more other embodiments, in block 2306, adjusting the luminance levels of pixels in one or more of the plurality of ranges includes removing noise from the shadow range and the midtone range of image 310 as described in connection with FIG. 12. Alternatively, adjusting the luminance levels of pixels in one or more of the plurality of ranges includes sharpening the highlight range of image 310 as described in connection with FIG. 13.

In block 2308, modified image 320 can be displayed on a display of the display device.

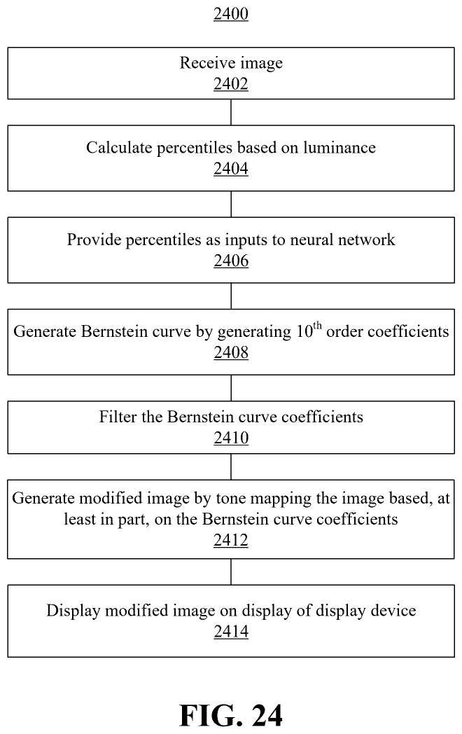

FIG. 24 illustrates a method 2400 of image processing in accordance with one or more embodiments of the disclosed technology. Method 2400 may be performed by a display device 100 as described in connection with FIGS. 2, 14, and 15 of this disclosure. The example of FIG. 24 is described with reference to processing an image. It should be appreciated that the processing described may be performed over a plurality of images, e.g., sequential frames, of multimedia content. The operations described in connection with FIG. 24 may be performed on SDR images or on HDR images. Further, the processing described in connection with FIG. 24 may be performed in real-time to support real-time video and/or multimedia playback.

In block 2402, input 110, e.g., image 310, is received. In block 2404, virtual input generator 202 is capable of calculating percentiles based on luminance. As part of block 2404, for example, histogram generator 1502 is capable of generating a histogram of image 310. Percentile calculator 1504 is capable of assigning the pixels to percentiles, e.g., 9 percentiles based on 9 predetermined percentages. In some embodiments, the calculating of percentiles corresponds to, e.g., implements an alternative embodiment with respect to, the assigning of pixels to a plurality of different ranges.

In block 2406, the percentiles are provided to neural network 1506 as inputs. Each percentile of pixels is provided to a particular one of the input nodes of neural network 1506 (e.g., on a one-to-one basis). In block 2408, neural network 1506 is capable of processing the received inputs and generating a Bernstein curve. For example, neural network 1506 is capable of outputting a plurality of Bernstein curve coefficients, e.g., 10^{th} order coefficients, that specify a Bernstein curve. The Bernstein curve, as generated by neural network 1506 once trained, reflects adjustments/changes in luminance of the different ranges of image 310 that mimic or reflect those that would be made by a human such as a colorist working on image 310 to generate a version of image 310 that may be displayed with reduced power.

In block 2410, filter 1508 is capable of filtering the Bernstein curve coefficients. In one or more embodiments, filter 1508 is implemented as an IIF. The filtering may be performed over a plurality of images to achieve temporal smoothing to avoid visual artifacts in multimedia content that may occur from one image/frame/scene to another.

In block 2412, virtual input generator 202 is capable of generating modified image 320 from image 310. In one or more embodiments, image 310 may be tone mapped based on the Bernstein curve coefficients as filtered. For example, tone mapper 1510, which may be implemented as a LUT, is capable of tone mapping image 310 to generate modified image 320 having power saving characteristics based on the received Bernstein curve coefficients.

The Bernstein curve coefficients may be used to adjust luminance levels of pixels in one or more or in each of the shadow range, the midtone range, and the highlight range. In one or more embodiments, a first subset of the plurality of Bernstein curve coefficients are used to adjust luminance levels of pixels in the shadow range (e.g., Bernstein curve coefficients P1, P2, and P3). A second subset of the plurality of Bernstein curve coefficients are used to adjust luminance levels of pixels in the midtone range (e.g., Bernstein curve coefficients P4, P5, and P6). A third subset of the plurality of Bernstein curve coefficients are used to adjust luminance levels of pixels in the highlight range (e.g., Bernstein curve coefficients P7, P8, and P9). P10 is always set to 1.

Accordingly, in some embodiments, the luminance levels of pixels in one or more of a plurality of ranges (e.g., the shadow range, the midtone range, and/or the highlight range) are changed using the LUT implementation of tone mapper 1510, which may be indexed to the Bernstein curve coefficients. As noted, different sets of the Bernstein curve coefficients may be indexed to modify pixels in different ranges.

Modified image 320 also may be input, or provided, to one or more conversion processes such as tone mapper 1404 to perform an SDR-to-HDR conversion, converter 204, or the like to produce a power saving output for rendering on the display device. As discussed, in some embodiments, the LUT implementation of tone mapper 1510 may be combined with the LUT implementation of tone mapper 1404 into a single LUT.

In block 2414, modified image 320 may be displayed on a display of a display device.

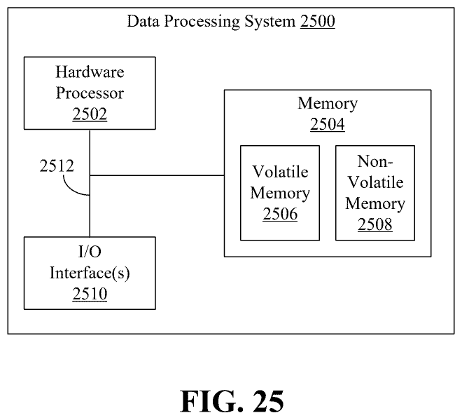

FIG. 25 illustrates an example of a data processing system 2500. As used herein, “data processing system” refers to one or more hardware systems capable of processing data. A computer system is an example of a data processing system. Each hardware system may include one or more hardware processors and memory. Data processing system 2500 is an example of a computer system that may be used to perform certain operations described such as the training of neural network 1506. In other embodiments, the image processing described herein may be implemented using a data processing system as described herein as part of a real-time process and/or an offline or post-production process. In other examples, data processing system 2500 may represent image processing circuitry of a display device.

Data processing system 2500 includes a hardware processor 2502. Hardware processor 2502 may be implemented as one or more hardware processors. Hardware processor 2502 may be implemented as one or more circuits capable of executing computer-readable program instructions (program instructions). The circuit(s) may comprise integrated circuits (ICs) or may be embedded within an IC. In one or more examples, hardware processor 2502 may be embodied as a central processing unit (CPU). Hardware processor 2502 may include one or more cores, for example, where each core is capable of executing computer-readable program instructions. Hardware processor 2502 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like.

In one or more other examples, hardware processor 2502 may be implemented as, or include, any of the various examples of hardware, e.g., image processing hardware, circuits, and/or ICs described herein. Such hardware, e.g., hardware accelerators, may be included in lieu of a CPU or included with a CPU such that both are capable of operating cooperatively.

Data processing system 2500 can include memory 2504. Memory 2504 may be embodied as one or more computer-readable storage mediums. Memory 2504 may include a volatile memory 2506 and a non-volatile memory 2508. Volatile memory 2506 may be embodied as random-access memory (RAM) and may include cache memory. Non-volatile memory 2508 may include a non-volatile magnetic medium and/or a solid-state medium (typically called a “hard drive”). Non-volatile memory 2508 also may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Memory 2504 is capable of storing program instructions and/or data such that hardware processor 2502 is capable of executing the program instructions to perform one or more operations as described within this disclosure. For example, the program instructions can include an operating system, one or more application programs, other program code, and program data. In some examples, memory 2504 may store program code and/or data to implement virtual input generator 202 as described in any of the figures herein and/or other operations described herein that may follow those performed by virtual input generator 202. Hardware processor 2502, in executing the computer-readable program instructions, is capable of performing the various operations described herein that are attributable to a computer and/or image processing circuitry.

Data processing system 2500 may include one or more Input/Output (I/O) interfaces 2510. I/O interface(s) 2510 allow data processing system 2500 to communicate with one or more external devices and/or communicate over one or more networks such as a local area network (LAN), a wide area network (WAN), and/or a public network (e.g., the Internet). Examples of I/O interfaces 2510 may include, but are not limited to, network cards, modems, network adapters (wired and/or wireless), hardware controllers, etc. Examples of external devices also may include devices that allow a user to interact with data processing system 2500 (e.g., display 104 such as professional display and/or panel, a keyboard, and/or a pointing device) and/or other devices such as an accelerator card.

Bus 2512 represents one or more of any of a variety of communication bus structures. By way of example, and not limitation, bus 2512 may be implemented as a Peripheral Component Interconnect Express (PCIe) bus. Bus 2512 couples to each of hardware processor 2502, memory 2504, and I/O interface(s) 2510 through respective interface circuitry thereby allowing the devices to communicate. Bus 2512 may represent a plurality of buses that may be interconnected and/or hierarchically organized.

Data processing system 2500 is only one example implementation. Data processing system 2500 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices. In other examples, data processing system 2500 may represent any of a variety of receiving devices as described herein.

The example of FIG. 25 is not intended to suggest any limitation as to the scope of use or functionality of example implementations described herein. Data processing system 2500 is an example of computer hardware that is capable of performing the various operations described within this disclosure. In this regard, data processing system 2500 may include fewer components than shown or additional components not illustrated in FIG. 25 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of computer readable storage mediums. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a Digital Signal Processor (DSP), a Graphics Processing Unit (GPU), and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or two or more, e.g., a plurality, of such mediums) having computer readable program instructions thereon for causing a processor to carry out aspects of the present disclosed technology. Within this disclosure, the term “program code” is used interchangeably with the terms “computer readable program instructions” and “program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A method, comprising:
assigning pixels of an image into a plurality of ranges based on luminance, wherein the plurality of ranges include at least one of a shadow range, a midtone range, or a highlight range; and
generating a modified image by adjusting luminance levels of pixels in one or more of the plurality of ranges;
wherein the adjusting improves perceptual brightness of the modified image relative to the image based on one or more visual illusions; and
wherein the adjusting reduces power consumption of displaying the modified image on a display device relative to displaying the image on the display device.

2. The method of claim 1, wherein the one or more visual illusions include a simultaneous contrast effect or a Bartleson-Breneman effect.

3. The method of claim 1, wherein the generating the modified image comprises:
generating a plurality of Bernstein curve coefficients for the image by providing luminance levels of pixels of the image to a neural network as input, wherein the neural network is trained to generate the plurality of Bernstein curve coefficients from luminance levels of pixels.

4. The method of claim 3, wherein a first subset of the plurality of Bernstein curve coefficients is used to adjust luminance of pixels of the shadow range, a second subset of the plurality of Bernstein curve coefficients is used to adjust luminance of pixels of the midtone range, and a third subset of the plurality of Bernstein curve coefficients is used to adjust luminance of pixels in the highlight range.

5. The method of claim 3, further comprising:
filtering the plurality of Bernstein curve coefficients over a plurality of images.

6. The method of claim 5, further comprising:
tone mapping the image based on the plurality of Bernstein curve coefficients as filtered.

7. The method of claim 3, wherein the luminance levels of pixels in one or more of the plurality of ranges are changed using a lookup table representing a curve specified by the plurality of Bernstein curve coefficients.

8. The method of claim 7, further comprising:
inputting the modified image into one or more conversion processes to produce a power saving output for rendering on the display device.

9. The method of claim 8, wherein the one or more conversion processes include a standard dynamic range to high dynamic range conversion process.

10. The method of claim 1, wherein the adjusting the luminance levels of pixels in one or more of the plurality of ranges comprises:
reducing the luminance levels of pixels in at least one of the shadow range, the midtone range, or the highlight range of the image; or
reducing the luminance levels of pixels in the shadow range and in the highlight range and increasing the luminance levels of pixels in the midtone range.

11. The method of claim 1, wherein the adjusting the luminance levels of pixels in one or more of the plurality of ranges comprises:
removing noise from the shadow range and the midtone range of the image; or
sharpening the highlight range.

12. The method of claim 1, further comprising:
displaying the modified image on a display of the display device.

13. A system, comprising:
one or more hardware processors adapted to perform image processing operations including:
assigning pixels of an image into a plurality of ranges based on luminance, wherein the plurality of ranges include at least one of a shadow range, a midtone range, or a highlight range; and
generating a modified image by adjusting luminance levels of pixels in one or more of the plurality of ranges;
wherein the adjusting improves perceptual brightness of the modified image relative to the image based on one or more visual illusions; and
wherein the adjusting reduces power consumption of displaying the modified image on a display device relative to displaying the image on the display device.

14. The system of claim 13, wherein the one or more visual illusions include a simultaneous contrast effect or a Bartleson-Breneman effect.

15. The system of claim 13, wherein the generating the modified image comprises:
generating a plurality of Bernstein curve coefficients for the image by providing luminance levels of pixels of the image to a neural network as input, wherein the neural network is trained to generate the plurality of Bernstein curve coefficients from luminance levels of pixels.

16. The system of claim 15, wherein a first subset of the plurality of Bernstein curve coefficients is used to adjust luminance of pixels of the shadow range, a second subset of the plurality of Bernstein curve coefficients is used to adjust luminance of pixels of the midtone range, and a third subset of the plurality of Bernstein curve coefficients is used to adjust luminance of pixels in the highlight range.

17. The system of claim 15, wherein the luminance levels of pixels in one or more of the plurality of ranges are changed using a lookup table representing a curve specified by the plurality of Bernstein curve coefficients.

18. The system of claim 13, wherein the adjusting the luminance levels of pixels in one or more of the plurality of ranges comprises:
reducing the luminance levels of pixels in at least one of the shadow range, the midtone range, or the highlight range of the image; or
reducing the luminance levels of pixels in the shadow range and in the highlight range and increasing the luminance of pixels in the midtone range.

19. The system of claim 13, wherein the adjusting the luminance levels of pixels in one or more of the plurality of ranges comprises:
removing noise from the shadow range and the midtone range of the image; or
sharpening the highlight range.

20. A computer program product, comprising:
one or more computer readable storage mediums, and program instructions collectively stored on the one or more computer readable storage mediums, wherein the program instructions are executable by one or more hardware processors to perform operations including:
assigning pixels of an image into a plurality of ranges based on luminance, wherein the plurality of ranges include at least one of a shadow range, a midtone range, or a highlight range; and
generating a modified image by adjusting luminance levels of pixels in one or more of the plurality of ranges;
wherein the adjusting improves perceptual brightness of the modified image relative to the image based on one or more visual illusions; and
wherein the adjusting reduces power consumption of displaying the modified image on a display device relative to displaying the image on the display device.
